(19) United States
(12) Patent Application Publication
(10) Pub. No.: US 2018/0146293 A1
(43) Pub. Date: May 24, 2018

(54) SYSTEMS, METHODS AND COMPUTER PROGRAM PRODUCTS PROVIDING A BONE CONDUCTION HEADBAND WITH A CROSS-PLATFORM APPLICATION PROGRAMMING INTERFACE

(71) Applicant: Muzik, LLC, Raleigh, NC (US)

(72) Inventor: Jason Hardi, Raleigh, NC (US)

(21) Appl. No.: 15/818,060

(22) Filed: Nov. 20, 2017

Related U.S. Application Data
(60) Provisional application No. 62/423,903, filed on Nov. 18, 2016.
(60) Provisional application No. 62/426,872, filed on Nov. 28, 2016.

(51) Int. Cl. H04R 5/033; H04R 1/10

(52) U.S. Cl. CPC H04R 5/0335; H04R 1/1041; H04R 2460/13; H04R 2420/07; H04R 1/1058; H04R 1/105

(57) ABSTRACT

An audio device can include a bone conduction headband configured to fit a user's head. A bone conduction headband extension that is coupled to the bone conduction headband, where the bone conduction headband extension can be configured to follow an inner contour of a user's ear when the bone conduction headband is worn to provide bone conduction audio transmission to a user. A touch sensitive input can be included on the bone conduction headband, where touch sensitive input can be configured to transmit a predetermined command associated with a function supported by a remote device wirelessly coupled to the bone conduction headband.

### CROSS-REFERENCE TO RELATED APPLICATION

The Application claims priority to U.S. Provisional Application Ser. No. 62/423,903 entitled Systems, Methods And Computer Program Products Providing A Bone Conduction Headband With A Cross-Platform Application Programming Interface, filed in the U.S.P.T.O on Nov. 18, 2016, and to U.S. Provisional Application Ser. No. 62/426,872 entitled Systems, Methods And Computer Program Products Providing Interconnected Speakers With A Cross-Platform Application Programming Interface filed in the U.S.P.T.O on Nov. 28, 2016, the entireties of each of which are hereby incorporated herein by reference.

### BACKGROUND

It is known to provide audio headphones with wireless connectivity which can support streaming of audio content to the headphones from a mobile device, such as the Smartphone. In such approaches, audio content that is stored on the mobile device is wirelessly streamed to the headphones for listening. Further, such headphones can wirelessly transmit commands to the mobile device for controlled streaming. For example, the audio headphones may transmit commands such as pause, play, skip, etc. to the mobile device which may be utilized by an application executed on the mobile device. Accordingly, such audio headphones support wirelessly receiving audio content for playback to the user as well as wireless transmission of commands to the mobile device for control of the audio playback to the user on the headphones.

### SUMMARY

Embodiments according to the present inventive concept can provide systems, methods and computer program products providing a bone conduction headband with a cross-platform application programming interface. Pursuant to these embodiments, an audio device can include a bone conduction headband configured to fit a user's head. A bone conduction headband extension that is coupled to the bone conduction headband, where the bone conduction headband extension can be configured to follow an inner contour of a user's ear when the bone conduction headband is worn to provide bone conduction audio transmission to a user. A touch sensitive input can be included on the bone conduction headband, where touch sensitive input can be configured to transmit a predetermined command associated with a function supported by a remote device wirelessly coupled to the bone conduction headband.

In some embodiments, an audio device can include a bone conduction headband configured to fit a user's head and a bone conduction headband extension, coupled to the bone conduction headband, where the bone conduction headband extension can be configured to follow an inner contour of a user's ear when the bone conduction headband is worn to provide bone conduction audio transmission to a user. An on-ear attachment can be removably coupled to the bone conduction headband extension, where the on-ear attachment is positioned opposite a user's ear canal when worn by the user to provide an audio signal through the user's ear canal.

### BRIEF DESCRIPTION OF DRAWINGS

FIGS. 1A and 1B are depictions of a bone conduction headband as worn by a user in some embodiments according to the inventive concept.

FIGS. 2A and 2B are depictions of a bone conduction headband including an on-ear attachment in some embodiments according to the inventive concept.

FIG. 3 illustrates a bone conduction headband within an operating environment in some embodiments according to the inventive concept.

FIG. 4A illustrates a cross-platform API capable of receiving input at an electronic device from the bone conduction headband for interaction with connected devices in some embodiments according to the inventive concept.

FIG. 4B illustrates a cross-platform API capable of receiving input at the electronic device from the bone conduction headband for interaction with connected devices in some embodiments according to the inventive concept.

FIG. 5 illustrates input provided at the bone conduction headband provided to the electronic device for operation of further devices in communication with electronic device such as connected device and/or server in some embodiments according to the inventive concept.

FIG. 6 illustrates a high-level block diagram showing an example architecture of the bone conduction headband which may implement the operations described herein in some embodiments according to the inventive concept.

FIG. 7 illustrates a high-level block diagram showing an example architecture of an electronic device as described herein, and which may implement the operations described herein in some embodiments according to the inventive concept.

### DETAILED DESCRIPTION

Advantages and features of the present inventive concepts and systems, methods, and computer program products of accomplishing the same may be understood more readily by reference to the following detailed description of example embodiments and the accompanying drawings. The present inventive concepts may, however, be embodied in many different forms and should not be construed as being limited to the embodiments set forth herein. Rather, these embodiments are provided so that this disclosure will be thorough and complete and will fully convey the present inventive concepts to those skilled in the art, and the present inventive concepts will only be defined by the appended claim. Like reference numerals refer to like elements throughout the specification.

As described herein below in greater detail, a bone conduction headband can be provided with “hot keys” so that users may more easily activate functions of the bone conduction headband as well as other connected devices. As will be appreciated given the benefit of the present disclosure, such a bone conduction headband can be utilized with conventional type calling as well as Voice Over IP calling, chat sessions, etc. The bone conduction headband according to the present invention can also be used by handicapped persons to improve accessibility using, for example voice recognition.

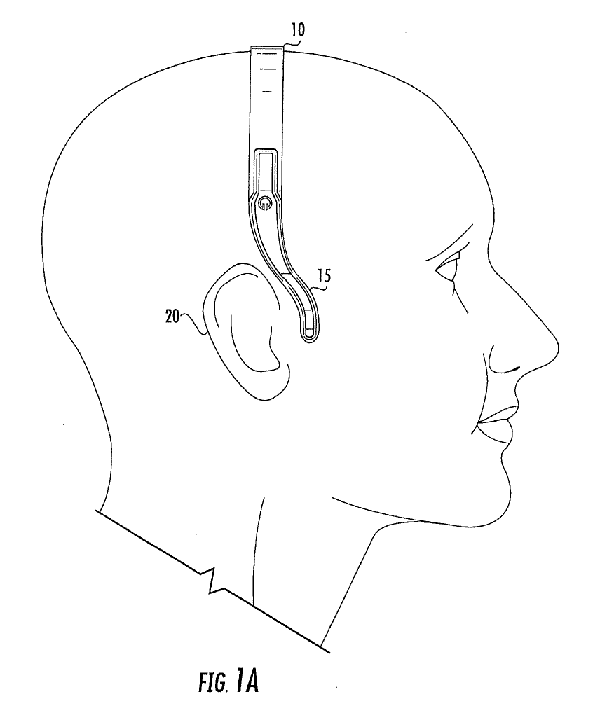

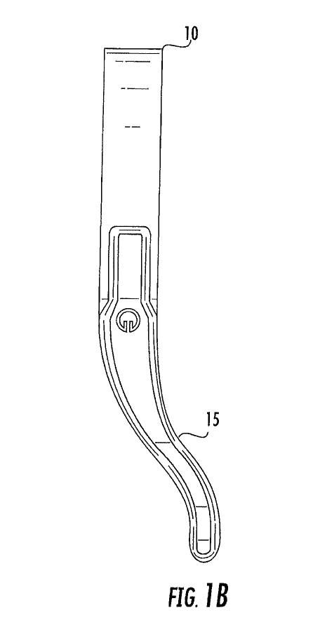

It will be understood that the bone conduction headbands described herein (such as those shown in FIGS. 1A and 1B herein) can have the same functionality of the headphones described in U.S. patent application Ser. No. 15/628,206, entitled Audio/Video Wearable Computer System with Integrated Projector, filed on Jun. 20, 2017, in the United States Patent and Trademark Office, the entirety of which is incorporated herein by reference. For example, the bone conduction headbands can be used in the place of any of the headphones shown in any of the embodiments therein.

FIG. 1A is a depiction of a bone conduction headband 10 as worn by a user 11 in some embodiments according to the invention. FIG. 1B is a side view of the same bone conduction headband 10 in some embodiments according to the invention. According to FIG. 1A, the bone conduction headband 10 includes a lower extension 15 which follows the inner contour of the ear 20 to provide audio to/from the headband 10 to communicate with a remote device. It will be understood that the bone conduction headband 10 can also include touch sensitive “hot keys” thereon so that the user 11 may activate predefined functions associated with remote devices, such as Voice Over IP applications, etc.

As further illustrated in FIGS. 1A and 1B, the bone conduction headband 10 closely follows the profile of the user's skull so that a small or no gap is left between the bone conduction headband 10 and the skull when worn by the user 11. Moreover, the lower extension 15 is configured for location over a portion of the user's skull to facilitate bone conduction audio transmission (i.e., transmission from outside the skull through bone to the Cochlea portion of the ear). In some embodiments, the bone conduction can be used by the hearing impaired to bypass the ear drum, such as would be used by hearing aid users.

The bone conduction headband may also include a microphone that enables the user to control other devices (such as a connected device). In some embodiments, the microphone may be used during telephone conversations, when for example the connected device is a VOIP modem.

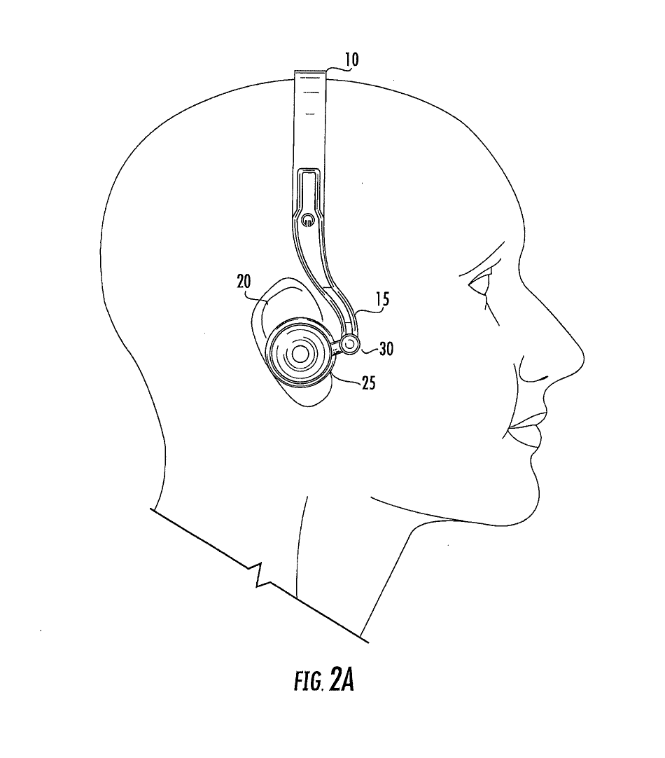

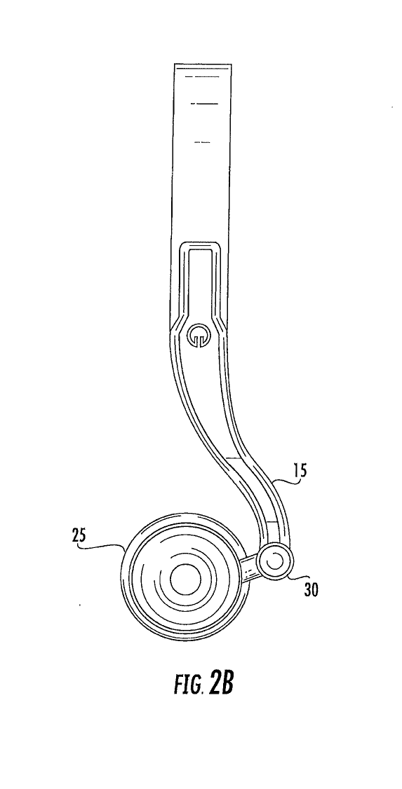

FIG. 2A is a depiction of the bone conduction headband 10 including an on-ear attachment 25 in some embodiments according to the invention. The on-ear attachment 25 can be removably coupled to the lower portion 15 of the bone conduction headband 10 by a coupling 31 so that rather than providing audio via bone conduction, an audio signal transmitted through the air into the ear 20 can be provided. It will be further understood that the attachment 25 can also include the hot keys that are predefined to activate certain functions associated with the remote device.

The on-ear attachment 25 can provide audio to the user 11 though the eardrum over the air. Accordingly, the on-ear attachment 25 can have many of the components found in some headphones, such as drivers, electronics, etc. It will be further understood that the bone conduction headband 10 can be configured to detect when the on-ear attachment 25 is coupled or decoupled from the lower extension 15. When the on-ear attachment 25 is coupled to the bone conduction headband 10, audio may be provided to user by both bone conduction (via the lower extension 15) and via the on-ear attachment 25. In some embodiments, audio may be provided only via the on-ear attachment 25. When, however, the on-ear attachment 25 is decoupled from the bone conduction headband 10, audio may be provided only via bone conduction.

The coupling 31 can be provided mechanically via, for example, a snap, connector, magnetics or the like. The audio may be provided from the lower extension 15 to the on-ear attachment 25 via a conductor that extends therebetween. In some embodiments, the audio may be provided from the lower extension 15 (or some other portion of the headband 10) to the on-ear attachment 25 wirelessly.

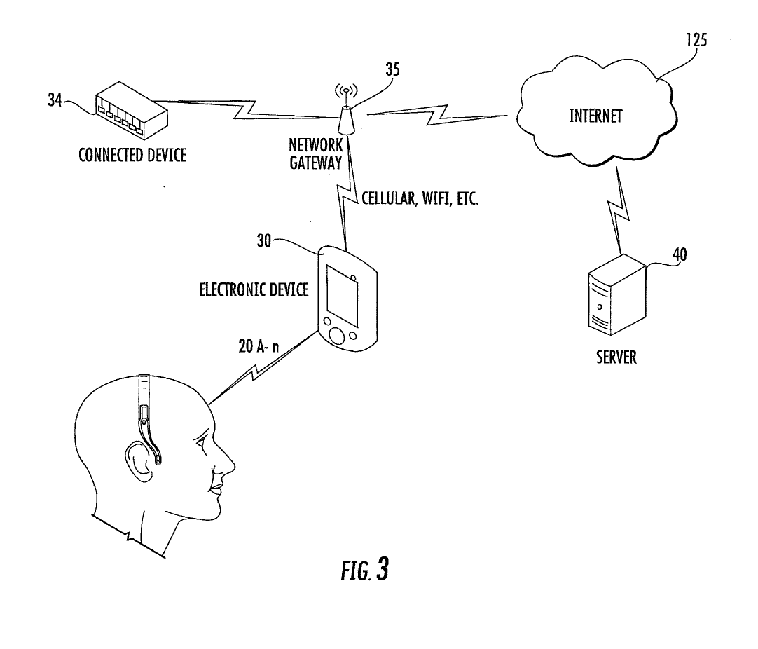

FIG. 3 illustrates an embodiment of a bone conduction headband 10 according to the present inventive concept within an operating environment. As illustrated in FIG. 3, the bone conduction headband 10 may be communicatively coupled to an electronic device 30 by one or more communication paths 20A-n. The communication paths 20A-n may include, for example, WiFi, USB, IEEE 1394, Bluetooth, Bluetooth Low-Energy, electrical wiring, and/or various forms of radio, though the present inventive concepts are not limited thereto. The communication paths 20A-n may be used simultaneously and, in some embodiments, in coordination with one another. The bone conduction headband 10 may exchange data and/or requests with the electronic device 30.

The electronic device 30 may be in further communication with an external server 40 through a network 125. In some embodiments, the network 125 may be a large network such as the global network more commonly known as the Internet. The electronic device 30 may be connected to the network 125 through intermediate gateways such as the network gateway 35. The electronic device 30 may be connected to the network gateway 35 through various means. For example, the network gateway 35 may be a radio-based telecommunication gateway, such as a base station, and the electronic device 30 may communicate with the network gateway 35 via radio communication such as that commonly used in cellular telephone networks. In some embodiments, the network gateway 35 may be network access point, and the electronic device 30 may communicate with the network gateway 35 via wireless network (“WiFi”). The network gateway 35 may further communicate with the network 125 via a communication method that is similar or different than the one used between the electronic device 30 and the network gateway 35. The communication paths described herein are not intended to be limiting. One of skill in the art will recognize that there are multiple technologies which can be used for connectivity between the electronic device 30 and the server 40 without deviating from the present inventive concepts.

The electronic device 30 may communicate with the server 40 to exchange information, data, and or requests. In some embodiments, the electronic device 30 may share data provided by the bone conduction headband 10 with the server 40. In some embodiments, as discussed further herein, the electronic device 30 may retrieve instructions and/or data from the server 40 responsive to input received from the bone conduction headband 10.

In some embodiments, the electronic device 30 may be communicatively coupled to a connected device 34. The connected device 34 can be any connected device that supports an associated application running in an operating environment of the electronic device 30. In some embodiments, as discussed further herein, the electronic device 30 may exchange data and/or control the connected device 34 responsive to input received from the bone conduction headband 10. Though illustrated as being connected to the connected device 34 through the network gateway 35, this illustration is not intended to be limiting. In some embodiments, the electronic device 30 may directly connect to the connected device 34 via similar communication paths as discussed with respect to communications paths 20A-n. For example, a path between the electronic device and the connected device 34 may include, for example, WiFi, USB, IEEE 1394, Bluetooth, Bluetooth Low-Energy, electrical wiring, and/or various forms of radio, though the present inventive concepts are not limited thereto. In some embodiments, the connected device 34 can be a Voice Over IP (VOIP) modem that supports calling using the bone conduction headband 10.

In some embodiments, the input received from the bone conduction headband 10 may be transmitted to the electronic device 30. The input provided by the bone conduction headband 10 may be used to interact with applications running on the electronic device 30 so as to control operations of the bone conduction headband 10, the server 40 and/or the connected device 34.

By varying the operation of applications running within an operating environment of the electronic device 30, the bone conduction headband 10 may be utilized to seamlessly control devices connected to the electronic device 30, as described herein.

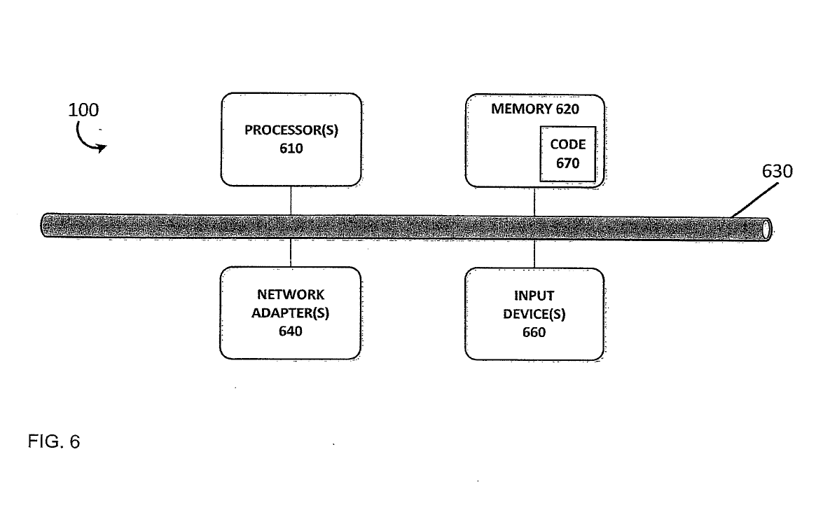

FIG. 6 illustrates a high-level block diagram showing an example architecture of the bone conduction headband 10, as described herein, and which may implement the operations described herein. The bone conduction headband 10 may include one or more processors 610 and memory 620 coupled to an interconnect 630. The interconnect 630 may be an abstraction that represents any one or more separate physical buses, point to point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire.”

The processor(s) 610 may control the overall operation of the bone conduction headband 10. As discussed herein, the one or more processors 610 may be configured to respond to input provided to the bone conduction headband 10 and transfer that input to the electronic device 30. In certain embodiments, the processor(s) 610 accomplish this by executing software or firmware stored in memory 620. The processor(s) 610 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the bone conduction headband 10. The memory 620 represents any form of random access memory (RAM), read-only memory (ROM), flash memory, or the like, or a combination of such devices. In use, the memory 620 may contain code 670 containing instructions according to the techniques disclosed herein.

Also, a network adapter 640 may be connected to the processor(s) 610 through the interconnect 630. The network adapter 640 may provide the bone conduction headband 10 with the ability to communicate with remote devices, including the electronic device 30, over a network and may be, for example, an Ethernet adapter, a Bluetooth adapter, etc. The network adapter 640 may also provide the bone conduction headband 10 with the ability to communicate with other computers.

The code 670 stored in memory 620 may be implemented as software and/or firmware to program the processor(s) 610 to carry out actions described above. In certain embodiments, such software or firmware may be initially provided to the bone conduction headband 10 by downloading it from a remote system through the bone conduction headband 10 (e.g., via network adapter 640). Though referenced as a single network adapter 640, it will be understood that the bone conduction headband 10 may contain multiple network adapters 640 that may be used to communicate over multiple types of networks.

One or more input device(s) 660 may also be connected to the processor(s) 610 through the interconnect 630. The input device(s) 660 may receive input from one or more sensors coupled to the bone conduction headband 10. For example, the input device(s) 660 may include touch-sensitive sensors and/or buttons. Though illustrated as a single element, the bone conduction headband 10 may include multiple input devices 660. The input device(s) 660 may communicate via the interconnect 630 with the memory 620, the processors 610, and/or the network adapter(s) 640 to store, analyze, and/or communicate the input received by the input device(s) 660 to the bone conduction headband 10.

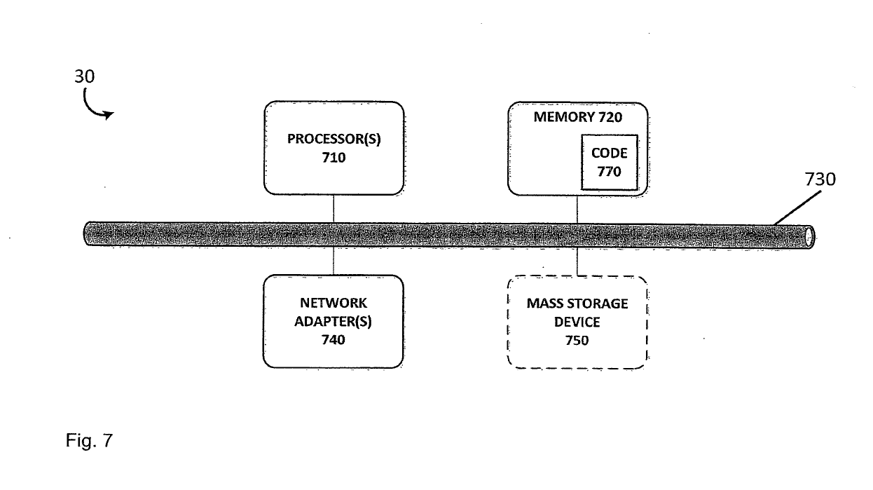

FIG. 7 illustrates a high-level block diagram showing an example architecture of an electronic device, such as electronic device 30, as described herein, and which may implement the operations described herein. The electronic device 30 may include one or more processors 710 and a memory 720 coupled to an interconnect 730. The interconnect 730 may be an abstraction that represents any one or more separate physical buses, point to point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire.”

The processor(s) 710 may control the overall operation of the electronic device 30. As discussed herein, the one or more processors 710 may be configured to receive input provided from the bone conduction headband 10 and execute operations of a common application programming interface (API) framework responsive to that input. In certain embodiments, the processor(s) 710 accomplish this by executing software or firmware stored in memory 720. The processor(s) 710 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 720 is or includes the main memory of the electronic device 30. The memory 720 represents any form of random access memory (RAM), read-only memory (ROM), flash memory, or the like, or a combination of such devices. In use, the memory 720 may contain code 770 containing instructions according to the techniques disclosed herein.

Also connected to the processor(s) 710 through the interconnect 730 are network adapter(s) 740. The network adapter(s) 740 may provide the electronic device 30 with the ability to communicate with remote devices, including the bone conduction headband 10, the connected device 34 (see FIG. 3) and/or the server 40 (see FIG. 3), over a network and may include, for example, an Ethernet adapter, a Bluetooth adapter, etc. The network adapter(s) 740 may also provide the electronic device 30 with the ability to communicate with other computers.

The code 770 stored in memory 720 may be implemented as software and/or firmware to program the processor(s) 710 to carry out actions described above. In certain embodiments, such software or firmware may be initially provided to the electronic device 30 by downloading it from a remote system (e.g., via network adapter 740).

Also optionally connected to the processor(s) 710 through the interconnect 730 are one or more mass storage devices 750. The mass storage device 750 may contain the code 770 for loading into the memory 720. The mass storage device 750 may also contain a data repository for storing configuration information related to the operation of the electronic device 30 and/or the bone conduction headband 10. That is to say that the mass storage device 750 may maintain data used to configure and/or operate the bone conduction headband 10. This data may be stored in the mass storage device 750 of the electronic device 30 and communicated to the bone conduction headband 10 via, for example, the network adapter 740.

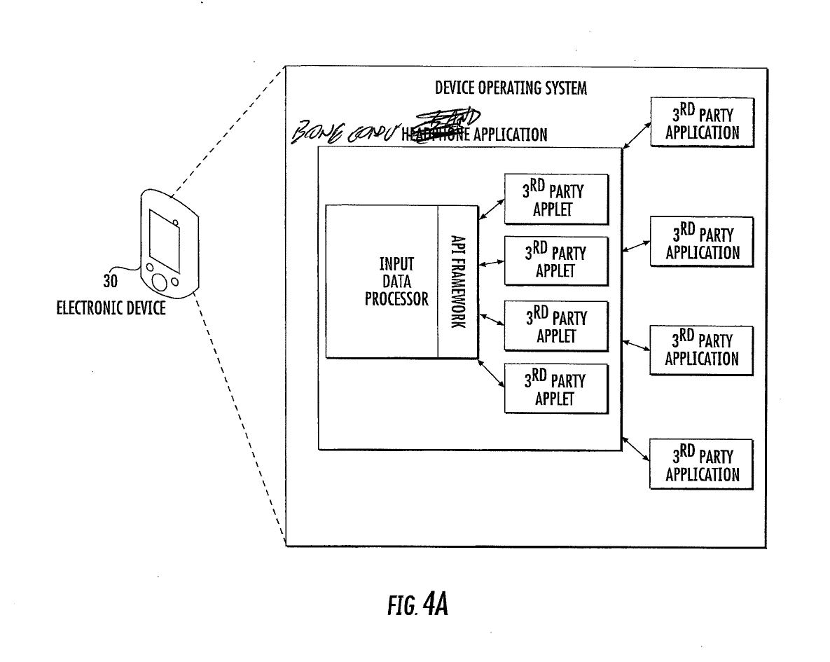

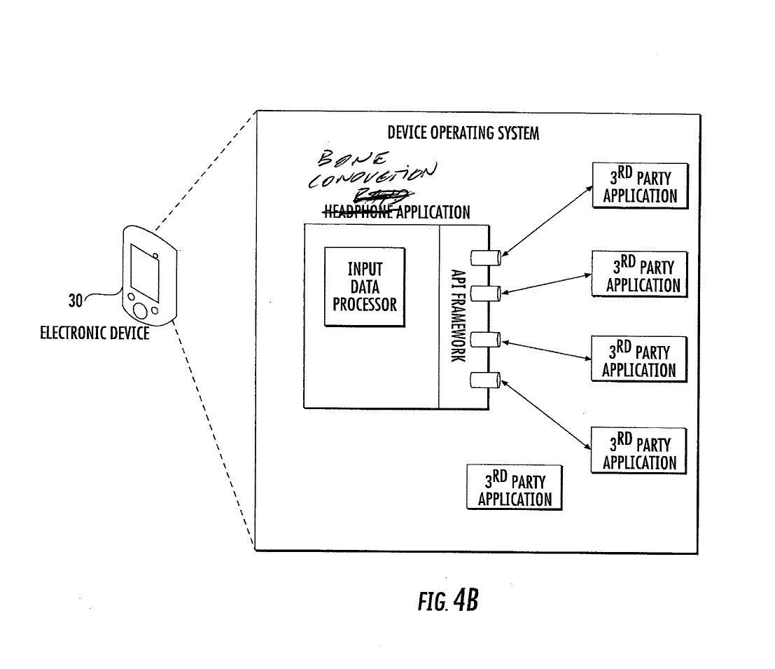

FIG. 4A illustrates an embodiment for a cross-platform API capable of receiving input at the electronic device 30 from the bone conduction headband 10 for interaction with connected devices.

As illustrated in FIG. 4A, the electronic device 30 may run a device operating system. In some embodiments, the device operating system may be a portable device operating system such as iOS or Android.

Within the device operating system, a bone conduction application may execute. The bone conduction application may be communicatively coupled to the bone conduction headband 10 via the electronic device 30.

Within the operating environment of the bone conduction application, there may be an input data processor. The input data processor may communicate with the bone conduction headband 10, the server 40 and/or the connected device 34. The input data processor may receive input signals from the bone conduction headband 10. The input signals may be received via the network adapter(s) 740 discussed herein with respect to FIG. 7. In other words, input may be received at the input devices 660 of the bone conduction headband 10 and transferred via the network adaptor(s) 640 of the bone conduction headband 10 to the network adapter(s) 740 of the electronic device 30. (See FIGS. 6 and 7.)

The input data processor may operate to provide the data from the input device of the bone conduction headband 10 to third party applications. For example, the input data processor may process audio or a gesture provided to the bone conduction headband 10 to a third party application for further processing by the third party application.

In some embodiments, the input data processor may first process the input provided by the bone conduction headband 10 before providing the input to the third party applications. For example, the input data processor may first analyze the input provided to determine if the input corresponds to a particular command and/or gesture. This analysis may include, for example, an examination of particular subcomponents of the input provided (e.g. a particular movement within the input) to determine whether the input matches a known configuration. The analysis may include determining whether the input matches a particular known input by a threshold amount.

Based on the analysis, the input data processor may determine that a particular input has been provided and further determine that the particular input has been configured to be associated with a particular third party application of a plurality of third party applications. Responsive to this determination, the input data processor may execute a command and/or provide data associated with the input to the third party application.

In some embodiments, the input data processor may provide the input provided by the bone conduction headband 10 directly to the third party application in addition to, or instead of, analyzing the input data provided by the bone conduction headband 10. That is to say that the input data processor of the bone conduction application may pass-through the input data directly to the third party application. The third party application may then process the input data for its own purposes.

As illustrated in FIG. 4A, in an embodiment of the present inventive concepts, the integration with the third party applications may be accomplished via an API framework coupled to the input data processor. The third party applications may provide respective third party applets which are configured to execute within the bone conduction application. The third party applets may be statically or dynamically linked to the bone conduction application.

The third party applets may be configured to send and/or receive data from the input data processor via the API framework. The API framework may be a complete implementation of all the functions by which data may be exchanged between the third party applets and the input data processor. Individual ones of the third party applets may implement some or all of the functions defined within the API framework.

Portions of the API framework may support specific classes of devices and/or device implementations. For example, the API framework may define classes such as an AUDIO device. Third party applets may implement commands to the generic devices and/or may implement customized commands specific to their implementation.

As illustrated in FIG. 4A, the third party applets may, in turn, communicate directly to their respective third party applications. The third party applications may also be executing within the device operating system. In some embodiments, the third party applications may communicate with additional externally connected devices, such as external server 40 and/or connected device 34. It will be understood that, in some embodiments, the third party applets within the bone conduction application may communicate directly with the additional externally connected devices, such as external server 40 and/or connected device 34 without first communicating with a third party application external to the bone conduction application.

By integrating with third party applications, the bone conduction application can provide connective functionality between the bone conduction headband 10 and other external devices and/or functions.

The bone conduction application may include a cross platform SDK that allows users to interact with third party applications that include artificial intelligence platforms, such as, for example, Siri, Cortana, Google Voice, Watson, etc.

FIG. 4B illustrates another embodiment for a cross-platform API capable of receiving input at the electronic device 30 from the bone conduction headband 10 for interaction with connected devices.

The embodiments of FIG. 4B are similar to those illustrated in FIG. 4A in that they include an Input Data Processor and API framework within a bone conduction application executing in a device operating system on the electronic device 30.

However, in the embodiment illustrated in FIG. 4B, the third party applications may communicate directly with the API framework without requiring the presence of third-party applets within the bone conduction application. In other words, the third party applications can dynamically access functionality of the API framework without a pre-existing third party applet. For example, the API framework may be provided as a client-server framework handling requests sent from the third party applications.

As illustrated in FIG. 4B, the bone conduction application may recognize the existence of third party applications within the device operating system which do not have a current connection to the bone conduction application. In some embodiments, the unconnected third party application may represent a newly-added connected device. Responsive to this detection, the bone conduction application may initiate communication with the third party application and/or prompt the user to perform actions to integrate the third party application. The communication with the third party application may take place over the API framework.

In will be understood that communication between the bone conduction application and respective ones of the third party applications may be unidirectional or bidirectional, and may be initiated by the bone conduction application or the third party application.

It will be understood by one of skill in the art that the embodiments of FIGS. 4A and 4B may be combined into an embodiment which utilizes the client-server framework described with respect to FIG. 4B as well as the statically/dynamically linked third party applets of FIG. 4A.

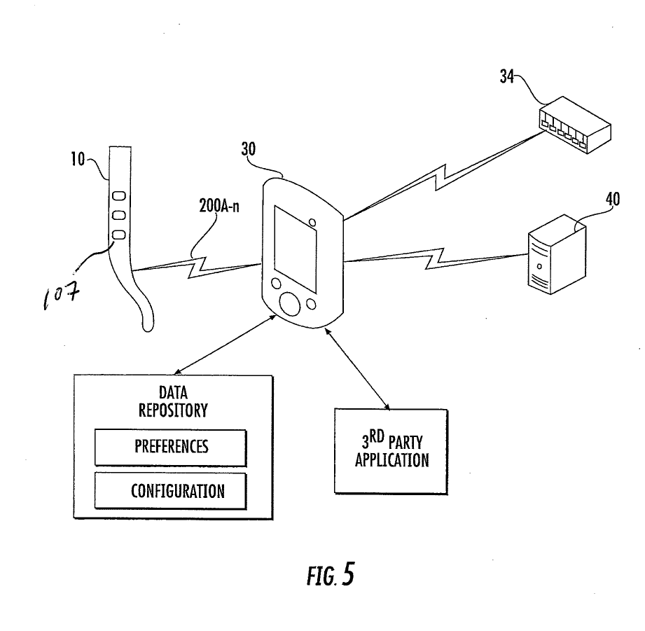

FIG. 5 illustrates an embodiment in which input provided at the bone conduction headband 10 is provided to the electronic device 30 for operation of further devices in communication with electronic device 30, such as connected device 34 and/or server 40.

As illustrated in FIG. 5, the bone conduction headband 10 may have an input sensor 107. In some embodiments, the input sensor 107 may be a touch sensitive control, such as a capacitive and/or resistive sensor. In some embodiments, the input sensor 107 may detect a touch of the user on the input sensor 107. In some embodiments, the input sensor 107 may be a proximity sensor capable of sensing input provided proximate to, but not necessarily touching, the input sensor 107. In some embodiments, the input sensor 107 may be one or more buttons.

In some embodiments, the input sensor 107 may be configured to detect a single touch of a user on or near the input sensor 107. In some embodiments, the input sensor 107 may be configured to detect a “swipe” comprising a sequential series of contacts across or near the input sensor 107. In some embodiments, the input sensor 107 may be configured to detect a series of touches and/or movements that comprise a gesture. Systems and methods for detecting user input comprising touches and gestures are described in U.S. patent application Ser. No. 14/751,952, entitled “Interactive Input Device,” the entire contents of which are included herein by reference.

As further illustrated in FIG. 5, the input received from the input sensor 107 may be provided to the electronic device 30. Upon receipt of the input, the electronic device 30 may determine that the input is to be used to control an additional device. In some embodiments, the additional device may be a connected device 34, an external server 40, and/or bone conduction headband 10, though the present inventive concepts are not limited thereto. It will be understood that although only single examples of the connected device 34 and an external server 40 are illustrated in FIG. 3, the number of devices capable of being accessed by the electronic device 30, is not limited thereto. For example, in some embodiments, the electronic device may be capable of controlling a plurality of connected devices 34 simultaneously in response to input data.

As used herein, the electronic device 30 may control the further devices, such as connected device 34 and/or the external server 40 in multiple ways. In some embodiments, the electronic device 30 may process the input data from the input sensor 107 and responsively operate portions of a third party application. In some embodiments, the electronic device 30 may pass on the input data from the input sensor 107 to the third party application, for the third party application to process. In some embodiments, the electronic device 30 may pass on the input data directly to the further device, such as connected device 34, external server 40, and/or bone conduction headband 10.

In some embodiments, the electronic device 30 may determine which further device and/or third party application to provide the input based on the contents of a data repository. In some embodiments, the data repository may contain configuration data and preferences data. The electronic device 30 may analyze the input first and then, based on the configuration data and/or preferences data, provide the input to the third party application and/or further device, such as the connected device 34 and/or the external server 40.

Though the third party application may communicate with a further device, such as the connected device 34, an external server 40, and/or bone conduction headband 10, it will be understood that not all input data must be communicated to an additional device. In some embodiments, the input data provided from the input sensor 107 may be communicated to a third party application that controls operations of the electronic device 30. For example, the third party application may control a volume of the electronic device 30.

The configuration data may indicate that certain input should be provided to a particular third party application and/or further device based on the type of input provided. For example, the configuration data may indicate that if a particular input is received, it is to be provided to a particular third party application. For example, the configuration data may indicate that a vertical swipe of the input sensor 107 is to advance a track of music currently playing. Upon receipt of such an input from the input sensor 107, the electronic device 30 may indicate to a third party application for playing music that a track-advance command has been received. The third party application for playing music may advance to a different music track and transmit the new music track to the bone conduction headband 10.

As another example, the configuration data may indicate that a complex shaped gesture received at the input sensor 107 is to share a particular piece of data with an external server 40. Upon receipt of such an input from the input sensor 107, the electronic device 30 may indicate to a third party application for sharing data that a message is to be sent to the external server 40. The third party application for sharing data may transmit the message to the external server 40 and the external server 40 may process the message.

As another example, the configuration data may indicate that a gesture shaped as an up-arrow received at the input sensor 107 is to increase a temperature of a connected device 34 comprising a networked thermostat or to operate a light using, for example, IFTTT protocol. Upon receipt of such an input from the input sensor 107, the electronic device 30 may indicate to a third party application controlling the connected device 34 that a temperature change is needed. The third party controlling the connected device 34 may transmit an appropriate communication, which may be proprietary to the connected device 34, to increase the temperature setting.

The configuration data may also indicate additional ways in which the electronic device 30 may determine which third party application and/or further device is to receive communication in response to the input data from the input sensor 107.

For example, in some embodiments, the third party application and/or device that will receive the communication in response to the input data from the input sensor 107 depends on which external devices are in communication with the electronic device 30. For example, a particular up-arrow gesture may be associated with the initiation of a VOIP call if VOIP modem is detected as being connected to the electronic device 30. If VOIP modem is not detected, the up-arrow gesture may be associated with an increase in temperature for a connected device 34, such as a networked thermostat, if connected device 34 is in communication with the electronic device 30. If neither the VOIP modem nor the connected device 34 is in communication with the electronic device 30, then the up-arrow gesture may be associated with increasing a volume of the electronic device 30. The electronic device 30 may dynamically change what operations are performed responsive to the input data from the input sensor 107 responsive to changing conditions on the electronic device 30.

In some embodiments, the third party application and/or device which receive the communication in response to the input data from the input sensor 107 may depend on which third party applications are currently operating on the electronic device 30 independently of any connected devices. For example, an upward gesture received as input from the input sensor 107 may be provided to a music application to advance a music track if a third party music application is running, and may be provided to a phone application to drop a current call if a call is currently active on the electronic device 30.

In some embodiments, the third party application and/or device which receive the communication in response to the input data from the input sensor 107 may depend on location of the electronic device 30. In some embodiments, the electronic device 30 may include functionality configured to determine the location of the electronic device 30. For example, the electronic device 30 may have a GPS sensor or other circuit capable of determining a current location. The electronic device 30 may use this current location to further differentiate which third party application may receive data corresponding to the input provided from the input sensor 107. For example, if the electronic device 30 determines that the electronic device 30 is currently located at a home of the user of the electronic device 30, the electronic device 30 may determine that a particular gesture received from the input sensor 107 is to be provided to a third party application associated with a connected device 34 including a thermostat. If the electronic device 30 determines that the electronic device 30 is currently located remote from the home of the user of the electronic device 30, the electronic device 30 may determine that the particular gesture received from the input sensor 107 is to be discarded, or, in some embodiments, to be provided to a third party application associated with an external server 40. The external server 40 may be configured to remotely connect to the thermostat at the house of the user of the electronic device 30.

The preference data on the electronic device 30 may indicate that certain input should be provided to a particular third party application and/or further device based on a user and/or system preference. For example, the preference data may indicate that a certain destination has priority if the electronic device 30 has multiple further devices and/or third party applications to which data associated with the input data from the input sensor 107 may be sent. The preference data may also indicate a particular mapping for a gesture to a particular operation by the electronic device 30. The preference data may, in some embodiments, override the configuration data.

In some embodiments, the preference data may be kept for a particular user. The preference data may be accessed by the electronic device 30 in response to a particular bone conduction headband 10 and/or an identification of a particular user using the bone conduction headband 10.

In some embodiments, the electronic device 30 may be capable of managing bone conduction headbands 10, and preference data may be maintained for each of the bone conduction headband controls. The preference data may be based on a particular unique value that is associated with the respective bone conduction headband that is passed to the electronic device 30 during communication with the bone conduction headband 10. For example, this unique value may include a serial number of the bone conduction headband 10, and/or an address of the bone conduction headband 10 on one of the communications paths 200A-n (see FIG. 1). In some embodiments, the electronic device 30 may be able to access an RFID associated with the bone conduction headband 10 to determine a unique identity for the bone conduction headband 10.

In some embodiments, the bone conduction headband 10 may have other inputs which allow a specific user to be identified. For example, in some embodiments, the bone conduction headband 10 may have a fingerprint sensor. The fingerprint sensor may allow a user of the bone conduction headband 10 to identify themselves to the electronic device 100 and access features of the bone conduction headband 10. In some embodiments, the electronic device 30 may use a fingerprint retrieved via bone conduction headband 10 to identify the user of the bone conduction headband 10 so as to load a particular set of preference data for the user. In some embodiments, the fingerprint sensor of the bone conduction headband 10 may be used as an additional identification and/or security device for the electronic device 30.

Embodiments of the present disclosure were described herein with reference to the accompanying drawings. Other embodiments may take many different forms and should not be construed as limited to the embodiments set forth herein. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. An audio device comprising:
a bone conduction headband configured to fit a user's head;
a bone conduction headband extension, coupled to the bone conduction headband, the bone conduction headband extension configured to follow an inner contour of a user's ear when the bone conduction headband is worn to provide bone conduction audio transmission to a user; and
a touch sensitive input on the bone conduction headband, touch sensitive input configured transmit a predetermined command associated with a function supported by a remote device wirelessly coupled to the bone conduction headband.

2. The device of claim 1 wherein the bone conduction headband extension is positioned opposite a user's Cochlea when worn.

3. The device of claim 2 wherein the bone conduction headband extension contacts the users head opposite the users Cochlea when worn.

4. The device of claim 1 further comprising:
a microphone configured to receive spoke audio signals from the user for wireless transmission to a remote device.

5. The device of claim 1 further comprising:
an on-ear attachment removably coupled to the bone conduction headband extension, wherein the on-ear attachment is positioned opposite a user's ear canal when worn by the user to provide an audio signal through the user's ear canal.

6. The device of claim 5 wherein the bone conduction headband extension is configured to provide bone conduction audio transmission and an audio signal to the user when the on-ear attachment is coupled to the bone conduction headband extension.

7. The device of claim 5 wherein the bone conduction headband extension is configured to disable bone conduction audio transmission when the on-ear attachment is coupled to the bone conduction headband extension.

8. The device of claim 4 wherein the bone conduction headband extension is configured to provide If This Then That (IFTTT) control of remote devices in response to spoken audio provided by the user.

9. The device of claim 4 wherein the bone conduction headband extension is configured to provide spoken audio provided by the user to an artificial intelligence platform.

10. The device of claim 5 an electrical signal corresponding to the audio signal is provided from the bone conduction headband extension to the on-ear attachment wirelessly.

11. An audio device comprising:
a bone conduction headband configured to fit a user's head;
a bone conduction headband extension, coupled to the bone conduction headband, the bone conduction headband extension configured to follow an inner contour of a user's ear when the bone conduction headband is worn to provide bone conduction audio transmission to a user; and
an on-ear attachment removably coupled to the bone conduction headband extension, wherein the on-ear attachment is positioned opposite a user's ear canal when worn by the user to provide an audio signal through the user's ear canal.

12. The device of claim 11 further comprising:
an input on the bone conduction headband, wherein the input is configured transmit a predetermined command associated with a function supported by a remote device wirelessly coupled to the bone conduction headband.

13. The device of claim 11 wherein the bone conduction headband extension is configured to provide bone conduction audio transmission and an audio signal to the user when the on-ear attachment is coupled to the bone conduction headband extension.

14. The device of claim 11 wherein the bone conduction headband extension is configured to disable bone conduction audio transmission when the on-ear attachment is coupled to the bone conduction headband extension.

15. The device of claim 11 further comprising:
a microphone, on the bone conduction headband, wherein the microphone is configured to receive spoke audio signals from the user for wireless transmission to a remote device.

16. The device of claim 12 wherein the input comprises a touch sensitive input is configured to recognize a gesture or swipe input.

17. The device of claim 12 wherein the input comprises a non-contact sensitive input configured to recognize a non-contacting gesture.
